(19) United States
(12) Patent Application Publication
(10) Pub. No.: US 2014/0006155 A1
(43) Pub. Date: Jan. 2, 2014

(54) INSTANT FLOOR PLAN AND MOBILE MARKETING MAP

(71) Applicants: Jesus J. Ramirez, San Diego, CA (US); Luis Ramirez, Watsonville, CA (US); Alfredo Ramirez, Watsonville, CA (US)

(72) Inventors: Jesus J. Ramirez, San Diego, CA (US); Luis Ramirez, Watsonville, CA (US); Alfredo Ramirez, Watsonville, CA (US)

(21) Appl. No.: 13/931,962

(22) Filed: Jun. 30, 2013

Related U.S. Application Data
(60) Provisional application No. 61/666,832, filed on Jun. 30, 2012.

(51) Int. Cl. G06Q 30/02

(52) U.S. Cl. CPC G06Q 30/0256
USPC 705/14.54

(57) ABSTRACT

The Instant Mobile Marketing Map (IMMM) provides an Instant Facility/Store Map (ISM) that gives detailed store floor plans, department layouts and individual items along with prices in order for customers to find products through the use of mobile devices or smart phones at any desirable location for any particular store involved within the system. The Instant Mobile Marketing Map (IMMM) additionally will have the marketing capability of making available a list of comparable products, those product prices, related products and available product sales along with coupons. Stores will have the opportunity to offer outstanding ads for certain articles, offer incentive sale prices to increase sales on articles to those using the Instant Mobile Marketing Map (IMMM) and to reduce the pressure on the sales clerks.

### FIELD OF THE INVENTION

An instant facility/store floor plan and mobile marketing map is provided to users of mobile devices having access to the Internet. More particularly, this invention provides a unique program and system that will aid customers using smart phones or mobile devices in facilities and stores to quickly locate articles they desire without the help of a present employee, for example a sales clerk, along with the added benefit of receiving advertising and coupons to related products.

### BACKGROUND OF THE INVENTION

When customers go to large stores (or many other facilities such as libraries, parks, airports, etc.) it is often hard to find one's way around the store even with all the signage. Sometimes customers end up walking around endlessly looking for an employee to point them in the right direction. The Instant Mobile Marketing Map (IMMM) through the Instant Facility/Store Map (ISM) solves this problem of finding the product you need by using a smart phone or mobile device. The idea stems from going to a hardware store and trying to find a product and there were no employees to be found for assistance. Many companies believe that if a customer gets lost in a store, the customer will find and buy other products that they originally did not intended to buy. Moreover, getting lost within a large facility and/or department store can seriously frustrate customers and/or visitors.

With smart phones or mobile devices being used more and more, people can be focused on their smart phones rather than the store signage for product location and advertisement. The introduction of the Instant Facility/Store Map (ISM) and the Instant Mobile Marketing Map (IMMM) is to provide direct marketing with a customer already at the store. It is logical to say that when a customer is at a retail store they are more likely to buy products if those products are marketed to them instantly. With smart phones or mobile devices the marketing and advertisement of specific products is made directly to the customer's smart phone or mobile device.

The Instant Mobile Marketing Map (IMMM) provides the tool for stores to market and advertise more products to customers using the smart phone. As a potential customer searches the store for a product using the Instant Facility/Store Map, first they are given the general location and are directed to the location of the product. The Instant Mobile Marketing Map (IMMM) then provides options for what type of products are available to buy. Product competitors can pay a premium for their products to be shown first and more outstanding to the customer. In addition, after the customer has chosen their product the Instant Mobile Marketing Map (IMMM) can market similar products or products related to the person's needs. There would also be a premium to be paid by a product supplier in order for their product to be shown to the user as a related or similar product.

The cultural influence on society has been enormous. More than two-thirds of our time on mobile phones is now used for non-communication activities with the average American spending 94 minutes per day utilizing mobile apps verses 72 minutes of web-based consumption. Mobile is poised to surpass television as the dominant consumer access point for all media. How we experience life, relationships, entertainment, education, exercise, and work have been completely transformed (for better or worse) because of mobile.

Despite mobile's progress and momentum, we're still only at the beginning of the golden age of mobile. There is still a huge gap between the rapid adoption of mobile and the budgets assigned to it. Brands will need to more than quadruple their mobile budgets to begin catching up to the levels at which consumers are embracing the channel. Statistics also show that globally “dumb-phone” users still outnumber smart phone users 5.6 billion to 835 million, meaning that the “upgrade cycle” to smart phones is still in the early stages. Imagine a world in the next 2-3 years, where smart phones are in the hands of every consumer and tablet sales will exceed PCs. It will be a world where global internet users will double, led by mobile usage. At that time, mobile will no longer be a support medium, it will be the primary medium. Today, we've already seen apps disrupt multi-billion dollar industries—gaming, retail, media, publishing, small business, photography, and travel.

In this respect, before explaining at least one embodiment of the Instant Mobile Marketing Map (IMMM) in detail it is to be understood that the design is not limited in its application to the details of construction and to the arrangement, of the components set forth in the following description or illustrated in the drawings. The Instant Mobile Marketing Map (IMMM) is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other programs, methods and systems for carrying out the several purposes of the present design. It is important, therefore, that the claims be regarded as including such equivalent construction insofar as they do not depart from the spirit and scope of the present application. Furthermore, it is intended to be used in any facility such as libraries, parks, airports, rail terminals, etc. and the use of a retail store is for example only and not meant to limit the scope of use of the ISM and IMMM.

### SUMMARY OF THE INVENTION

The principal advantage Instant Mobile Marketing Map (IMMM) program is to provide the Instant Facility/Store Map (ISM) along with a unique marketing system.

An advantage of the Instant Facility/Store Map is to supply a customer with a smart phone or mobile device the precise location of the product that they desire within the store.

Another advantage of the Instant Facility/Store Map is to provide a customer that has a smart phone or mobile device with a map directing them how to get to the area within the store where the product they desire is located.

Another advantage of the Instant Facility/Store Map would be that before even arriving at the store a person with a smart phone or mobile device would be able to search the store for inventory and location of the desired products.

Another advantage of the Instant Facility/Store Map would be to reduce the pressure on store clerks to find the products that each customer is looking for.

An advantage of the Instant Mobile Marketing Map program would be that before even arriving at the store a person with a smart phone or mobile device can review a variety of similar products to the one that they had in mind.

Another advantage of the Instant Mobile Marketing Map program would be that before even arriving at the store a person with a smart phone or mobile device can review a variety of related items to the product that they intended to purchase.

Another advantage of the Instant Mobile Marketing Map program would be that before even arriving at the store a person with a smart phone or mobile device can review a price comparison between articles similar to the one they intend to purchase.

Another advantage of the Instant Mobile Marketing Map program would be that before even arriving at the store a person with a smart phone or mobile device can see if there are any coupons or store specials on the article that they intend to purchase.

Another advantage of the Instant Mobile Marketing Map program would be the profits derived from the advertising from the product suppliers.

Yet another advantage of the Instant Mobile Marketing Map program would be the increased profits when suppliers are competing for the most desirable and outstanding location on the product listing.

And still another advantage of the Instant Mobile Marketing Map program would be the increased profits when suppliers of related products would pay for the advertising.

The Instant Mobile Marketing Map (IMMM) program will be deployed through the use of internet access on the personal smart phones or mobile devices. It would also make available a list of comparable products, product prices, related products and available product sales along with coupons. Stores will have the opportunity to offer incentive sale prices on articles to those using the Instant Mobile Marketing Map (IMMM) in order to reduce the pressure on the sales clerks. Other features of the system may include voice command, for example when a user calls for products they show up on the display screen. The voice command would then guide a user through the rest of the entire program/system. Another possibility that is anticipated by this disclosure is that the instant program/system may incorporate applications (known commonly as “apps”), and these apps may be run on a smart phone or mobile device.

When a person is searching through a prior art internet based map with a smart phone or mobile device for a desired type of store in a particular area, the store is then found and brought up along with the directions to its location. The Instant Mobile Marketing Map (IMMM) program can be activated to bring up an optional link to the store. The Instant Store Map provides a floor plan (map) and location of products in the store.

The Instant Store Map also provides a store search engine for products and their specific locations. More particularly, the Instant Store Map provides the help that store clerks would be able to provide in finding a particular product. However, before even arriving at the store a person with as smart phone would be able to search the store for inventory and location of the desired products through the Instant Store Map (ISM). A customer would be able to save time while informing themselves if a store carries a certain product and would also be able to receive recommended products that relate to the targeted product to be purchased. The additional marketing method in this proposed application involves stores providing their store floor plans (maps), product locations and option for inventory. Through this marketing method stores will market products differently and product suppliers will want to advertise their products through the Instant Mobile Marketing Map (IMMM) system, program and site.

The advertising money is the incentive for the stores involvement in the Instant Mobile Marketing Map (IMMM) program. Every product will be competing to be at the top of the customer search list when they initially search a product. The store and the product supplier can negotiation in order to get that product at the top of the advertisement list. Take for example a large store where it has roughly 120,000 items it sells and assuming that each item has four competitors. You are dealing with four or more product suppliers who are competing for the number one spot on the advertisement list. If 30,000 suppliers are willing to pay to be at the top of the advertisement list, then a lot of money can be generated on advertisement store products. When it comes to providing inventory, companies can opt-out, however it would be relatively simple to install their inventory system and floor plan in the Instant Store Map system and provide the customer a real time inventory.

Four marketing methods that may be used are described herein, with the first being that with Instant Mobile Marketing Map (IMMM) program, once the customer has found the desired item and chooses the specific brand or manufacturer of the product the customer is then given a “pop-up” of an advertisement of the item and similar items that are possibly on sale. The suppliers pay a fee for these advertisements.

The second marketing method of the Instant Mobile Marketing Map (IMMM) program would be a customer has chosen the product and has overlooked (or closed) a given “pop-up” advertisement (from previous paragraph) and is then given a list of items that are also possibly on sale with the item or items at the top of the list being more outstanding than the general list of items. There will be additional fees to the supplier for these outstanding advertisements. So, being at the top of this list is the essence of the second marketing method.

The third marketing method of the Instant Mobile Marketing Map (IMMM) program would be after the customer has chosen the specific item or when they have searched for the type or model there will be a link to related items. If the customer clicks on any additional items there will be a fee to the suppliers of these items.

Marketing Method 4 is where Map Zoom will be as you zoom in or out of the maps, users will be able to see store advertisement of products (small icons that can be clicked on). Product Companies can market their products or brand. They can market their brand by putting an icon of the company brand. Depending upon the level of zoom, the layer reached will also dictate the number of advertisements seen by the user.

With the Instant Mobile Marketing Map (IMMM) program companies would be paying a fee to market their products in Map Zoom Marketing Method 4.

### Example

As you zoom into the electronics department you are able to see the small icons that you can click on to see the full advertisement or what's on sale. Also, as a user zooms in the user will be able to see brand name icon.

Incorporate 3D Shelves which means that people can see in 3D the shelves and products. 3D shelves also include real life images of store shelving and 3D computer generated images (computer animated).

Fees charged to product companies that wish to advertise can be flat fees or percentage fees as stated in marketing methods 1, 2, 3 and 4. Percentage fees can be based on a certain percent of average product sales or any other parallel method. Negotiation of these fees with the product companies is an option.

Product location services or store has interact capability to keep user on the right path to find product (GPS or inventory positioning system). This is how the present ISM/IMMM system will work to locate items. By using GPS capability or sensors on products (or shelves) detection capabilities, an Internet based smart phone or mobile device can readily locate the correct shelf, product, or other item or location. In this case, it is meant that for location of certain items not only for store products but also for items within any facility such as a library, park, airport, etc.

Instant Mobile Marketing Map (IMMM) is not only for stores but for all areas that need a more accurate mapping based system like, airports, hardware stores, shopping centers, malls, libraries, parks, restrooms, public areas (museums) and in general all residential, commercial, government locations, etc.

The Instant Mobile Marketing Map (IMMM) program can be used by users from any part of the world by using multiple languages.

A person can have a shopping list and put their items on a shopping cart. If a person has items on the shopping list they can choose the item at any time and get the mapping directions to the item and add it to the shopping cart.

Social Media Networks such as Google and/or Facebook, or others subsequently developed and deployed acting like Facebook and/or Google, may be incorporated into the Instant Mobile Marketing Map (IMMM) program marketing plan as customers can at the time of item selection or purchase of a product can choose “LIKE” (Facebook) or “Plus 1” (Google Plus). This provides products with direct (real time) advertisement/exposure by customers at the time of product selection or purchase. This is another reason why product suppliers would be very interested in paying an extra premium to have their products shown as advertisements when customers do a search.

The foregoing has outlined rather broadly the more pertinent and important features of the Instant Mobile Marketing Map (IMMM) program in order that the detailed description of the application that follows may be better understood so that the present contribution to the art may be more fully appreciated. Additional features of the design will be described hereinafter which form the subject of the claims of this disclosure. It should be appreciated by those skilled in the art that the conception and the disclosed specific embodiment may be readily utilized as a basis for modifying or designing other structures and methods for carrying out the same purposes of the present design. It should also be realized by those skilled in the art that such equivalent constructions and methods do not depart from the spirit and scope of this application as set forth in the appended claims.

### BRIEF DESCRIPTION OF THE DRAWINGS

The accompanying drawings, which are incorporated in and form a part of this specification, illustrate embodiments of the Instant Mobile Marketing Map (IMMM) program and together with the description, serve to explain the principles of this application.

FIG. 1 depicts a block diagram of the Instant Mobile Marketing Map (IMMM) program;

FIG. 2 shows an embodiment of the delivery of the computer implemented web-based system over the Internet;

FIG. 3 depicts a block diagram of the prior art Internet Base Map system;

FIG. 4 depicts a block diagram of the Instant Facility/Store Map (ISM) system;

FIG. 5 depicts a continuation of the block diagram of the Instant Store Map system;

FIG. 6 depicts a block diagram of a typical store floor plan;

FIG. 7 depicts a block diagram of a typical electronics department;

FIG. 8 depicts a block diagram of a typical advertisement;

FIG. 9 is a block diagram depicting the process after the person has chosen the desired product; and

FIG. 10 is a block diagram depicting the process of using marketing method four using map zoom features.

For a fuller understanding of the nature and advantages of the Instant Mobile Marketing Map (IMMM) program reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

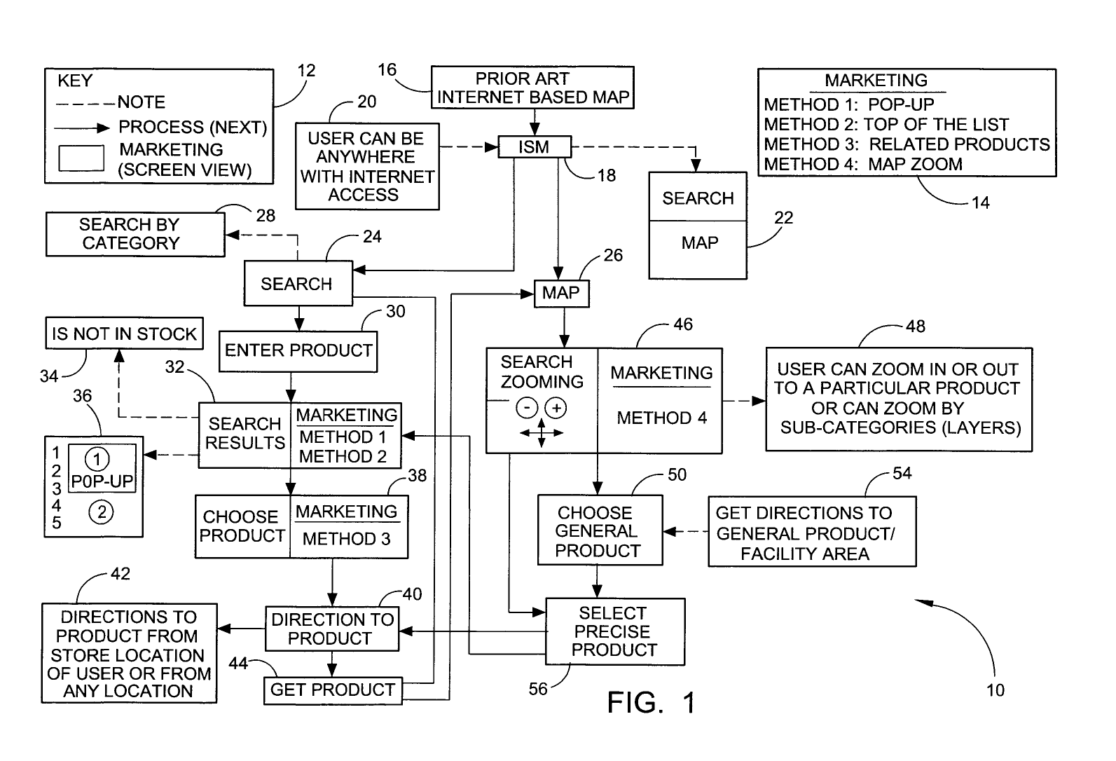

Referring now to the drawings, wherein similar parts of the Instant Mobile Marketing Map (IMMM) program 10 are identified by like reference numerals, there is seen in FIG. 1 a block diagram of the Instant Mobile Marketing Map (IMMM) program 10 with a Key 12 indicating the meaning of the different symbols and lines found on the diagram and block 14 indicating the four marketing methods.

The prior art Internet Based Map block 16 is initially used to locate a specific store location and then the Instant Store Map system (ISM) 18 can be brought up where the user can be anywhere with internet access designated in block 20 and search to a map indicated in block 22 before going to the search product in block 24 or to the map block 26. From map block 26 the user can search by category indicated in block 28 or enter the product shown in block 30 and then go to search results and marketing methods one and two indicated in block 32 where you can see if it is in stock 34 or receive a pop-up (marketing method 1) and item from top of the list (marketing method 2) as indicated by block 36 or go directly to choosing the product while receiving marketing method three depicted in block 38. It is anticipated by this disclosure of the present invention, that deployment of the invention may be done using the internet, WiFi, LAN, WAN, WWAN, RFID and any other wireless type of localized system of communicating.

After choosing the product user can get directions to the product indicated in block 40 where the user can get directions to product from store location or from any location indicated in block 42 or just get the product indicated in block 44. Additionally after map box 26 user can search by zooming marketing method four indicated in block 46 where the user can zoom to a particular product or can zoom by sub-categories (layers) indicated in block 48 or choose the general product indicated in block 50. Then user can get directions to all similar products indicated in block 54. While in search by zooming marketing method four indicated in block 46 user can select the precise product indicated in block 56 and go to get directions to the product as indicated in block 49 or choose product search results and be routed as indicated in block 32.

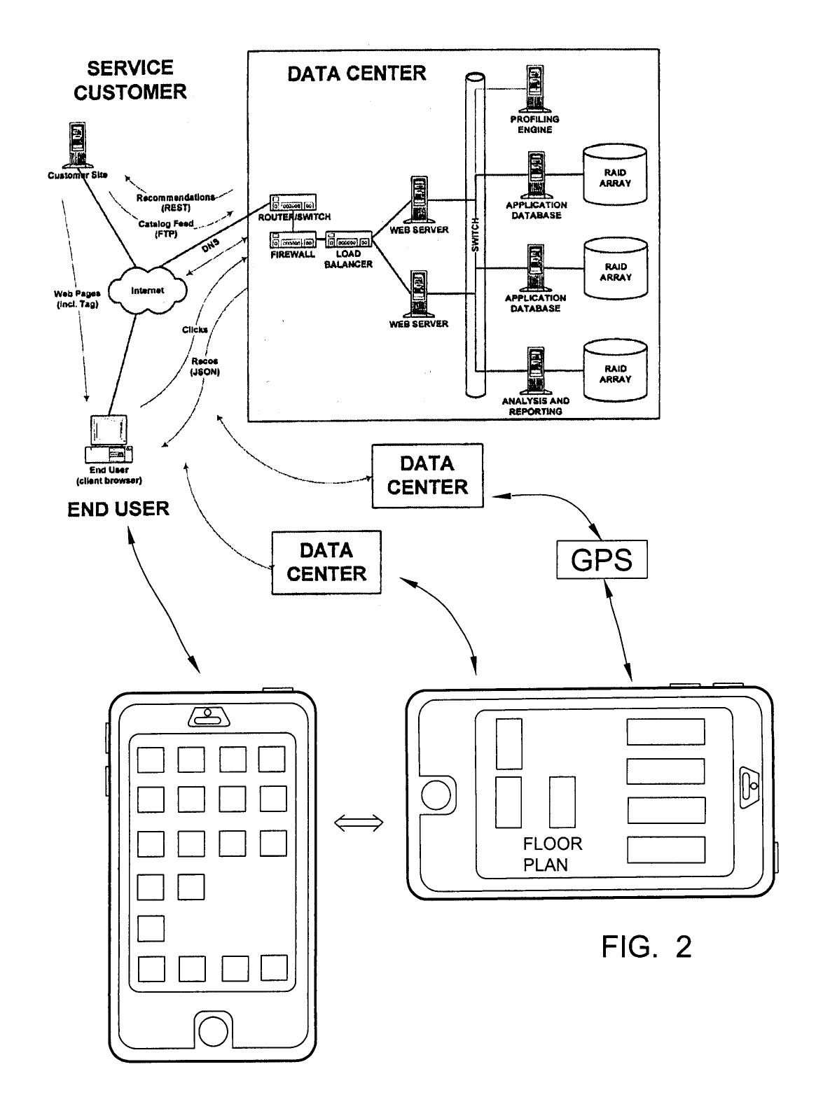

FIG. 2 shows an embodiment of the delivery of the computer implemented web-based system over the Internet. The end use application (Service Customer) is a website that is external to the system and that communicates with the system via web services from the customer website or directly from the customer website's end user's client browser. As shown, the system ma be distributed across multiple computers on a network. This consists of one or more web servers (or web farm), which collect data and process content recommendation requests. The web servers pass data to one or more application databases via a message queuing system that allows the web servers to continue processing while the much slower database servers feed the data into permanent storage, such as non-volatile RAM, direct-attached RAID array, network attached storage (NAS), or storage area network (SAN).

Additionally, one or more data centers are used to retrieve floor plan maps and other data from an application database and uses the data to generate the delivered floor plans and product information as well as advertising associated to the products and related products. The resulting web-based computer implemented Instant Mobile Marketing Map (IMMM) system and Instant Store Map system (ISM) works on any fixed or mobile computer able to access the Internet. It is anticipated that the system will also work wirelessly through the use of an application (also known as “apps”) located on a mobile phone or smartphone. The system may also use the smartphone's GPS system to locate the user and deliver the floor plan of the store/facility being visited. Moreover, the system may collect customer use data for the purpose of targeting future customers, and may be connected to social media sites for product/item related communications therein.

FIG. 3 depicts a block diagram of the prior art Internet Base Map system 16 where the person with the mobile internet device is shown in block 60 can search for the desired store using the internet based device shown in block 62 then find the desire store using the internet based map in block 64. The person gets the directions to the desired store using the internet based map 16 and once the directions are given an icon with the option to click on the store will appear shown in block 66.

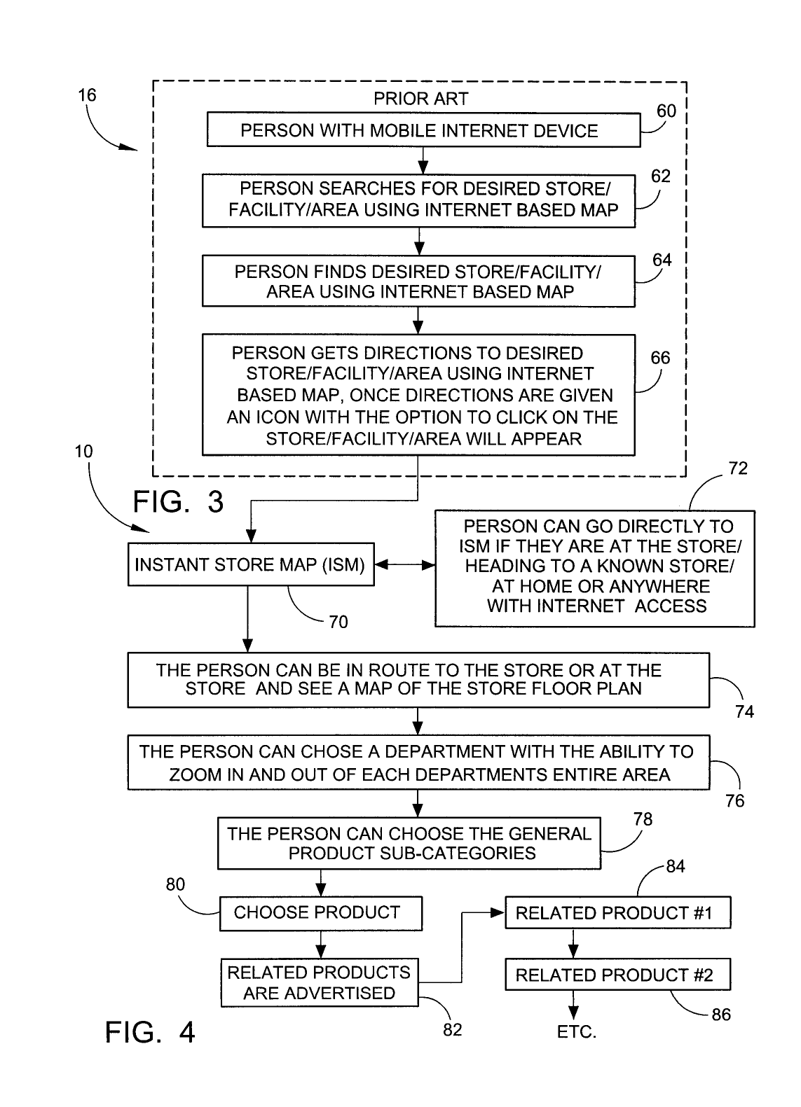

FIG. 4 depicts a block diagram of the Instant Mobile Marketing Map (IMMM) program 10 illustrating where the Instant Store Map (ISM) in block 70 after receiving the information from the prior art Internet Store Map system 16 the person can go directly to ISM if they are at the store or heading to a known store or at home or anywhere with internet shown in block 72. The person can be in route to the store or at the store and see a map of the store floor plan 74. From the Instant Store Map (ISM) 70 the person can either search for product as indicated in block 24 (same as block 26) or can choose a department with the ability to zoom in and out of departments entire area shown in block 76. The person can then choose the general product sub-categories shown in block 78 then choose the product shown in block 80 and the related products are advertised in block 82. The related products advertised can be Related Product #1 in block 84, and Related Product #2 in block 86 along with any additional products.

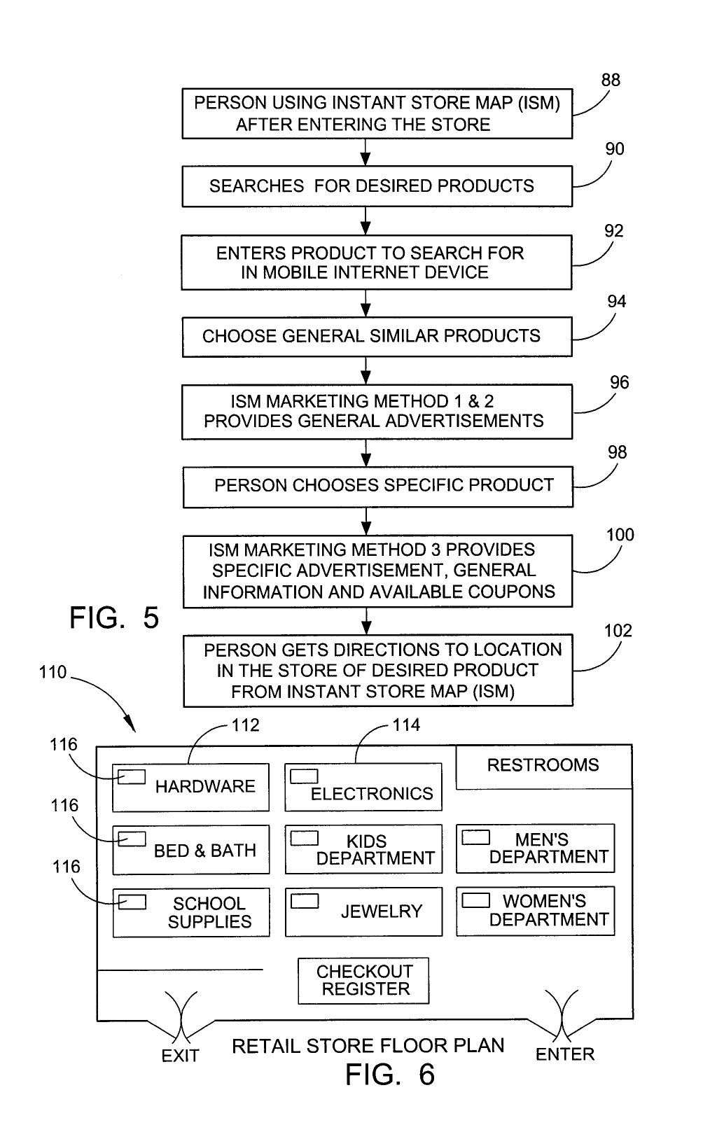

FIG. 5 depicts a continuation of the block diagram of the Instant Mobile Marketing Map (IMMM) system 10 where a person using the Instant Store Map (ISM) 70, for example after entering the store shown in block 88 searches for the desired product shown in block 90 then enters the product to search for in the mobile internet device shown in block 92. The person then chooses general similar product shown in block 94 and then ISM marketing method 1 and 2 provides general advertisements shown in block 96 and the person chooses specific product shown in block 98. ISM marketing method 3 provides specific advertisements, general information and available coupons shown in block 100 and the person gets directions to the location in the store of the desired product from the Instant Facility/Store Map (ISM) shown in block 102.

FIG. 6 depicts a block diagram of a typical store floor plan 110 that illustrates the different typical department locations, such as hardware shown in block 112 and electronics in block 114 with marketing blocks 11 in the corners illustrating advertisements, general information and available coupons.

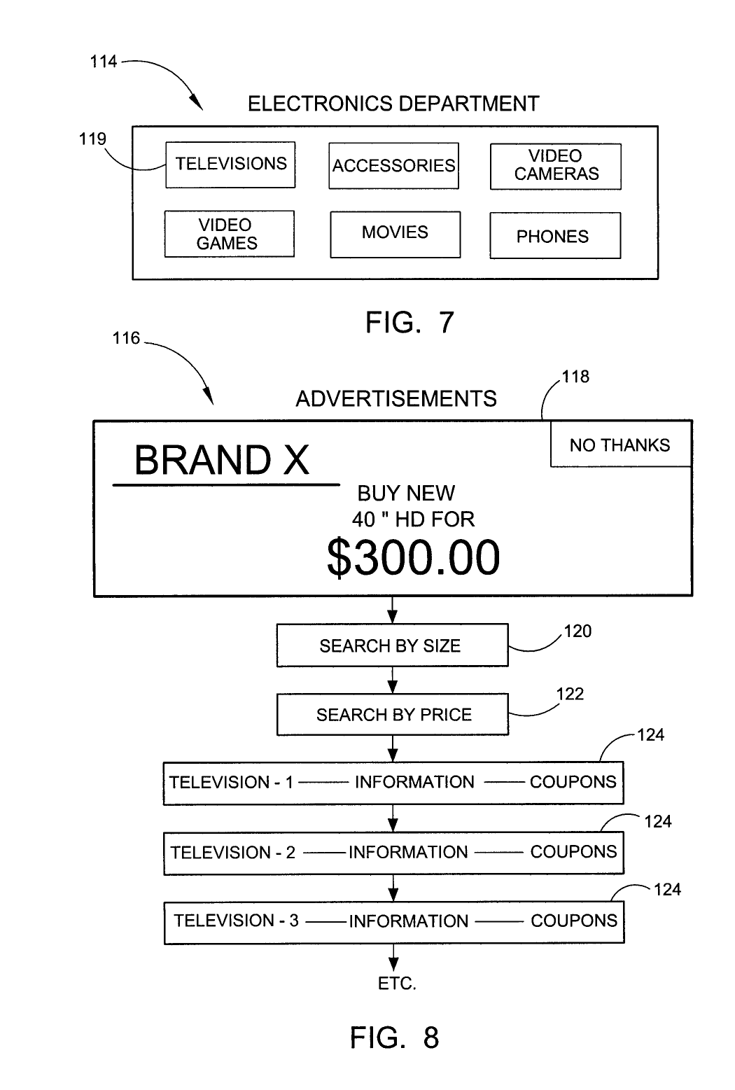

FIG. 7 depicts a block diagram of an electronics department 114 with the televisions shown in block 119 among other items in that department.

FIG. 8 depicts a block diagram of a typical marketing advertisement 116 with the first advertisements displayed as bold outstanding advertisements shown in block 118 then to search by size shown in block 120 and search by price shown in block 122 then smaller advertisements such as televisions 1, 2, 3, etc. along with information and coupons are displayed in successive blocks 124.

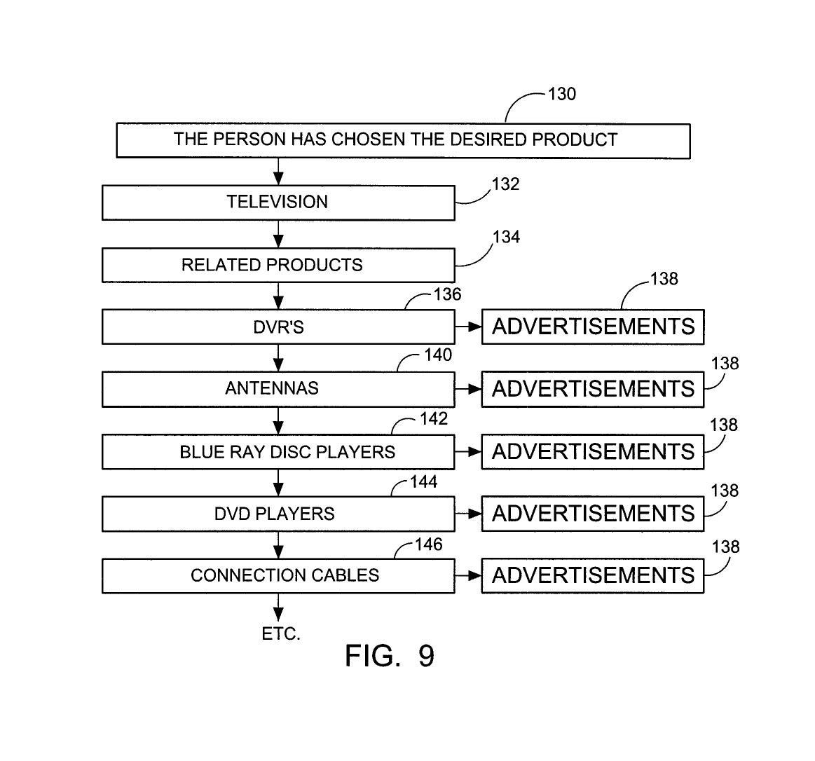

FIG. 9 is a block diagram indicates the marketing process after the person has chosen the desired product depicted in block 130 such as a television shown in block 132 with related products shown in block 134. The related products may consist of DVR's in block 136 with advertisements in block 138, antennas in block 140, blue ray disc players in block 142, DVD players in block 144, connection cables in block 146 each having the connections to similar advertisements 138.

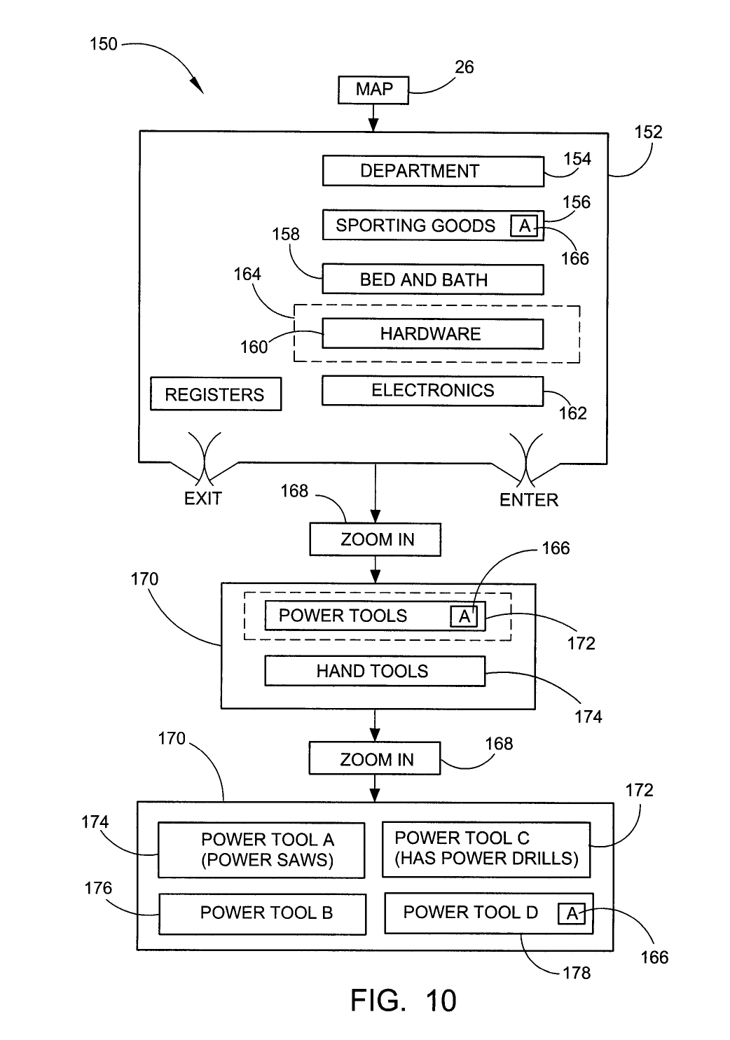

FIG. 10 depicts a block diagram of marketing method four 150, starting with acquisition of the map 26 (see FIG. 1). In this example, the user/customer is searching for a power drill, and the map 26 leads the user to the complete floor plan (plan view) of the store 152, in which numerous departments are shown, such as department 154, sporting goods 156, bed and bath 158, hardware 160 and electronics 162. As is shown in the sporting goods department 156, an advertiser can place an ad “A” 166 by paying a fee, and as such may be the only advertiser to have an ad 166 on the complete store layout 152, at this point where the complete store layout 152 is shown on the map. Since the user/customer is looking for a power drill, then he or she clicks on the hardware department 160 and the screen zooms in 168 to show more detail within the hardware department 170.

Within the zoomed in view of the hardware department 170 there is shown the aisles of power tools 172 and hand tools 174 locations. Within the power tools aisle an advertiser may place an ad “A” 166 by paying the required fee to do so. The customer/user then clicks to zoom in 168 closer to the power tools aisle 172, and this reveals greater detail of what is on the shelves, such as power tool A 174 (power saws), power tool B 176, power tool C 172 (which has the desired product power drills, in this case) and power tools D 178. An advertiser (or another company) can also pay to have an ad in any of these given locations, such as ad “A” 166 as shown here in the power tool D 178 location. By clicking on power tool C 172 which has the desired power drills the customer is searching for, this takes the customer to search results and marketing methods one and two indicated in block 32 of FIG. 1 (see FIG. 1).

The Instant Mobile Marketing Map (IMMM) program 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Mobile Marketing Map (IMMM) program 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A web-based computer implemented instant floor plan and mobile marketing map application system for providing an instant facility/store map on a mobile computer capable of wirelessly accessing a global computer network and further providing mobile access to marketing information in which a user can search for a product/item and locate that product/item on said provided facility/store floor plan map, then be presented with advertisements and buying suggestions for said product/item.

2. The web-based computer implemented instant floor plan and mobile marketing map application system for providing an instant facility/store map on a mobile computer capable of wirelessly accessing a global computer network and further providing mobile access to marketing information, according to claim 1, in which a user can search for a product/item and locate that product/item on said provided facility/store floor plan map, then be presented with advertisements and buying suggestions for said product/item, including products/items related to said product/item.

3. The web-based computer implemented instant floor plan and mobile marketing map application system for providing an instant facility/store map on to mobile computer capable of wirelessly accessing a global, computer network and further providing mobile access to marketing information, according to claim 1, wherein said system includes providing a department store floor plan and advertisements for department store products/items.

4. The web-based computer implemented instant floor plan and mobile marketing map application system for providing an instant facility/store map on a mobile computer capable of wirelessly accessing a global computer network and further providing mobile access to marketing information, according to claim 3, wherein said system provides facility/store department location detail and advertisements related to products/items in said store department.

5. The web-based computer implemented instant floor plan and mobile marketing map application system for providing an instant facility/store map on a mobile computer capable of wirelessly accessing a global computer network and further providing mobile access to marketing information, according to claim 4, wherein said system provides facility/store department aisle location detail and advertisements related to products/items in said store department aisle.

6. The web-based computer implemented instant floor plan and mobile marketing map application system for providing an instant facility/store map on a mobile computer capable of wirelessly accessing a global computer network and further providing mobile access to marketing information, according to claim 5, wherein said system provides facility/store department aisle shelf location detail and advertisements related to products/items in said store department aisle shelf.

7. The web-based computer implemented instant floor plan and mobile marketing map application system for providing an instant facility/store map on a mobile computer capable of wirelessly accessing a global computer network and further providing mobile access to marketing information, according to claim 4, wherein said systems provides sales coupons and special sales information for products/items within said store department.

8. The web-based computer implemented instant floor plan and mobile marketing map application system for providing an instant facility/store map on a mobile computer capable of wirelessly accessing a global computer network and further providing mobile access to marketing information, according to claim 5, wherein said systems provides sales coupons and special sales information for products/items within said store department aisle.

9. The web-based computer implemented instant floor plan and mobile marketing map application system for providing an instant facility/store map on to mobile computer capable of wirelessly accessing a global computer network and further providing mobile access to marketing information, according to claim 6, wherein said systems provides sales coupons and special sales information for products/items within said store department aisle shelf.

10. The web-based computer implemented instant floor plan and mobile marketing map application system for providing an instant facility/store map on a mobile computer capable of wirelessly accessing a global computer network and further providing mobile access to marketing information, according to claim 7, wherein said systems provides sales coupons and special sales information for products/items related to said products/items within said store department.

11. The web-based computer implemented instant floor plan and mobile marketing map application system for providing an instant facility/store map on a mobile computer capable of wirelessly accessing a global computer network and further providing mobile access to marketing information, according to claim 1, wherein said facility/store includes a library, park, and airport and like facilities.

12. A web-based computer implemented instant floor plan and mobile marketing map application method for providing an instant facility/store map on a mobile computer capable of wirelessly accessing a global computer network and further providing mobile access to marketing information via mobile marketing of products to a user of an instant store map comprising the steps of:
presenting the user with a floor plan map of a facility/store;
acquiring the product/item the user is searching for;
providing a list of products/items along with the products facility/store location; and
presenting an advertisement for said products/items to the user.

13. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 12, further comprising the steps of:
locating an advertisement at any point in the display of the list of products/items presented; and
locating advertisements of said products/items shown within the department map locations from said floor plan of a facility/store.

14. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 13, wherein the system presents a floor plan of a facility/store department and displays advertising related to that department.

15. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 14, wherein the system presents a floor plan of a facility/store department and displays advertising related to that department and further provides sale coupons and sale information for products/items within said department and related products/items.

16. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 13, wherein the system presents a floor plan of a facility/store department aisle and displays advertising related to that department isle.

17. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 16, wherein the system presents a floor plan of a facility/store department aisle and displays advertising related to that department aisle and further provides sale coupons and sale information for products/items within said department aisle and related products/items.

18. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 13, wherein the system presents a floor plan of a facility/store department aisle shelf and displays advertising related to that department aisle shelf.

19. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 18, wherein the system presents a floor plan of a facility/store department aisle shelf and displays advertising related to that department aisle shelf and further provides sale coupons and sale information for products/items within said department aisle shelf and related products/items.

20. The web-based computer implemented instant floor plan and mobile marketing map application method for providing an instant facility/store map on a mobile computer capable of wirelessly accessing a global computer network and further providing mobile access to marketing information via mobile marketing of products to a user of an instant store map, according to claim 13, wherein said facility/store includes a library, park, airport or like facility.
